(19) United States
(12) Patent Application Publication
(10) Pub. No.: US 2010/0320789 A1
(43) Pub. Date: Dec. 23, 2010

(54) Railway car independent axles

(76) Inventor: Larry Markus Karlson, Prince George (CA)

Correspondence Address: Antony C. Edwards, Unit 206 - 3500 Carrington Road, Westbank, BC, V4T 3C1, CA

(21) Appl. No.: 12/457,724

(22) Filed: Jun. 19, 2009

(51) Int. Cl. B60B 35/00

(52) U.S. Cl. 295/39

(57) ABSTRACT

A railway car axle includes a first stub axle mounted in a rigid hollow sleeve. The first stub axle has opposite inner and outer ends, and the sleeve has a first open end and an oppositely disposed first terminal end. A first bore is defined by a cylindrical wall extending from the first open end to the first terminal end. The first stub axle is journalled in the first bore so as to position the inner end of the first stub axle adjacent the first terminal end and so that the outer end of the first stub axle extends from the first open end. Separate first inner and first outer bearing housings, and corresponding first bearings, are mounted tight to the inner ends of the first stub axle or to outer housing and the first open end of the sleeve respectively so as to allow rotation of the first stub axle relative to the sleeve. Means are provided for retaining the first stub axle in the first bore. A mirror image may be provided for mounting a second stub axle in the sleeve. The stiffness for resisting bending of the axle due to downward loading of the axle laterally outwardly of wheels mounted on the ends of the axle is provided by the wall thickness of the sleeve.

### FIELD OF THE INVENTION

This invention relates to the field of railway car axles that, in conjunction with wheels mounted on the axles, bear the weight of railway cars riding on rails, and in particular relates to railway car axles which are formed of at least one independent section having its inner end journalled in a casing or sleeve so as to permit free rotation of one axle section relative to the other axle section when the railway car is travelling around curves in the rails.

### BACKGROUND OF THE INVENTION

The prior art is replete with attempts to allow independent rotation of oppositely disposed railway car wheels which are oppositely disposed on the opposite ends of an axle. For example in one early illustration, applicant is aware of U.S. Pat. No. 12,572, which issued Mar. 20, 1855 to Prentiss for a Car Axle. More particularly however applicant is aware of prior art having the specific object of providing a segmented axle extending between oppositely disposed railway car wheels for the purpose of permitting free rotation of one axle section relative to the other axle section when travelling around curves as for example stated in U.S. Pat. No. 977,002 which issued Nov. 29, 1910 to Girt et al for an Independent Car Axle, or so as to allow the wheels to operate independently of each other to thereby reduce the friction when the car is going around a curve and so that the outer wheel can revolve faster than the inner one, as taught in U.S. Pat. No. 205,324 which issued Jun. 25, 1878 to Whittic for a Car-Axel, or so as to reduce friction and consequent wear of car wheels and track when passing around a curve as taught in U.S. Pat. No. 302,120 which issued Jul. 15, 1884 to Fleming for a Car Axel, or, so as to provide car axles which permit their two wheels to turn independently of each other by the insertion of two separate short axles into opposite ends of a long sleeve or tube which connects the short axles and holds them in line as taught in U.S. Pat. No. 134,247 which issued Dec. 24, 1872 to Braymer et al for Car-Axles.

What is neither taught nor suggested in the prior art and which—is an object of the present invention to provide is a simple yet load and bending moment resistant arrangement of independent axle sections, and which advantageously may be retrofit into existing one-piece axles, for use on the style of railway cars where the load is applied on the transversely outward side of the wheels so as to apply an upward bending moment urging the centre of the axle upwardly, and in particular for use on railway truck wheel and axle sets as disclosed by way of example in U.S. Pat. No. 3,802,352 which issued to The Timken Company on Apr. 9, 1974 for the invention of Keller. A copy of FIG. 1 from the Keller patent forms the prior art FIG. 1 of the present specification.

By way of illustration of the problem that is addressed by the present invention, in applicant's experience, conventional car axle housings, bushings and bearings are designed to carry in the order of 230,000 lbs between four axles under a car and that these loads are distributed to the wheels by loads applied to conventional bearings mounted on the laterally outermost ends of car axles where the axles protrude from the corresponding pair of oppositely disposed wheels. Thus loads in the order of approximately 60,000 lbs bear down on each of the outermost ends of the conventional unitary axles thereby exerting a bending moment on both ends of the axles which urges the axles to bow upwardly into a curve. In a conventional axle the loads are substantially resisted by the use of steel axles having a significant cross-sectional diameter, in the order of approximately seven and eight inches in applicant's experience. It is thus advantageous to replicate the load and bending moment bearing capabilities of a conventional solid axle in a segmented axle which provides for independent rotation of the opposite wheels on each axle and which also advantageously may be retrofitted to existing conventional solid axles.

### SUMMARY OF THE INVENTION

In summary, the railway car axle according to one aspect of the present invention may be characterized as including a first stub axle mounted in a rigid hollow sleeve. The first stub axle has opposite inner and outer ends, and the sleeve has a first open end and an oppositely disposed first terminal end. A first bore is defined by a cylindrical wall extending from the first open end to the first terminal end. The first stub axle is journalled in the first bore so as to position the inner end of the first stub axle adjacent the first terminal end and so that the outer end of the first stub axle extends from the first open end.

Separate first inner and first outer housings for bushrings or bearings also referred to collectively herein as bearings, and corresponding first bearings, are mounted tight to the inner ends of the first stub axle or to the housing and the first open end of the sleeve respectively so as to allow rotation of the first stub axle relative to the sleeve. Means are provided for retaining the first stub axle in the first bore.

The outer end of the first stub axle is adapted for mounting of a railway car wheel thereon and is further adapted for bearing a downward load associated with the railway car on load bearings mounted on an outermost end of the outer end of the first stub axle. The load bearings are thus displaced laterally outwardly of the railway car wheel when mounted on the outer end of the first stub axle.

The cylindrical wall of the sleeve has a wall thickness. The wall thickness is sufficient to provide stiffness substantially equivalent to a stiffness afforded by a solid shaft of a length substantially equivalent to a corresponding length of the sleeve when the solid shaft has a diameter substantially equivalent to a diameter of the first stub axle.

The first stub axle has a first length which may be at least substantially one-half of the length of the sleeve. Alternatively the first length may be substantially equivalent to the length of the sleeve.

In a further embodiment, a second bore may be formed in the sleeve oppositely disposed to and co-linearly with the first bore on opposite sides of a common terminal end wall disposed therebetween. The second bore extends from a second open end to a second terminal end, and wherein the first and second terminal ends are oppositely disposed faces on the opposite sides of the common terminal end wall. A second stub axle having opposite inner and outer ends is mounted in the second bore so as to position the inner end of the second stub axle adjacent the second terminal end and so that outer end of the second stub axle extends from the second open end. Again, separate second inner and second outer bearing housings, and corresponding second bearings, are mounted tight to the inner end of the second stub axle or housing and the second open end of the sleeve respectively so as to allow rotation of the second stub axle relative to the sleeve. Means are provided for retaining the second stub axle in the second bore.

Again, the outer end of the second stub axle is adapted for mounting of a railway car wheel thereon and is further adapted for bearing a downward load associated with the railway car on load bearings which are mounted on an outermost end of the outer end of the second stub axle so as to be displaced laterally outwardly of the railway car wheel when mounted on the outer end of the second stub axle.

Advantageously, the diameter of the first stub axle is substantially equal to the diameter of the second stub axle. Further, the first or second terminal ends may be shaped so as to cup their corresponding inner ends of their stub axles. For example, the inner end of the first stub axle may be truncated by a substantially planar face which is orthogonal to said bore. A thrust bearing may be mounted in the terminal end adjacent the planar face. Shims may be mounted adjacent the thrust bearing. Nylon may be inserted or injected to provide low friction surfaces.

The means for retaining the first stub axle in the first bore and the means for retaining the second stub axle in the second bore may include annular grooves in the first and second stub axles and correspondingly positioned apertures in the sleeve for receiving therethrough rigid elongate members into registry with the grooves when the first and second stub axles are mounted in the first and second bores respectively. For example, the apertures may be bolt holes and the members may be bolts.

The present invention in applicant's experience reduces wear on wheels and rails and power and power required to pull rail cars, and reduces drag by about 25 percent in corners when measured a 1/18 scale model weighted down with 250 pounds.

### BRIEF DESCRIPTION OF THE DRAWINGS

FIG. 1 is, in perspective view, a prior art railway car track.

FIG. 2a is in partially cut-away perspective view, a railway car axle according to one embodiment of the present invention.

FIG. 2b is a front elevation view of the axle of FIG. 2a.

FIG. 2c is an end elevation view of the axle of FIG. 2a.

FIG. 3 is an alternative embodiment of the railway car axle of FIG. 2.

FIG. 4 is yet a further embodiment of the railway car axle of FIG. 2.

FIG. 5 is the front elevation of FIG. 2a showing the dimensions of one embodiment, which are not intended to be limiting.

FIG. 6 is a sectional view along line 6-6 in FIG. 5.

FIG. 7 is an exploded view of the axle of FIG. 2a.

### DETAILED DESCRIPTION OF EMBODIMENTS OF THE INVENTION

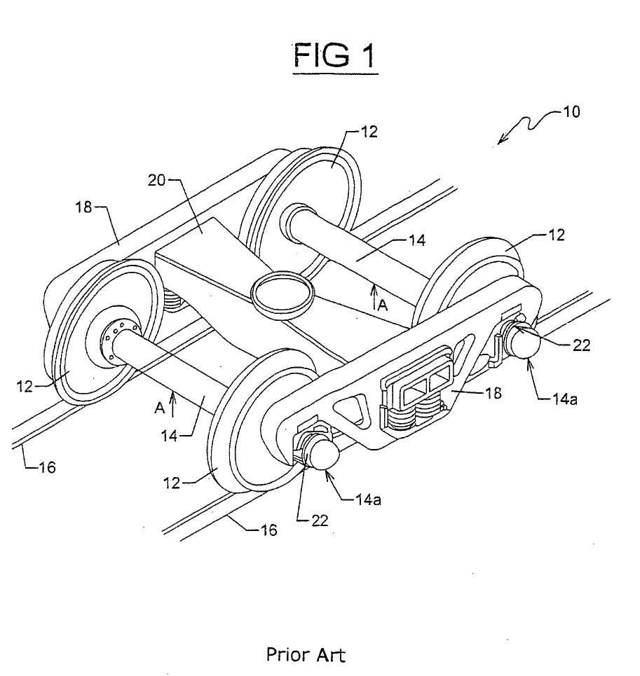

As seen in the accompanying figures wherein similar characters of reference to note corresponding parts in each view, FIG. 1 illustrates a prior art railway car truck 10 wherein wheels 12 are rigidly mounted onto the opposite ends of shafts 14 for rolling on rails 16. Load bearing members 18 transfer the load from the railway car (not shown) via cross-member 20 so as to distribute the load down onto axles 14 and thence to wheels 12 by loads applied substantially equally to the opposite-most ends 14a of axles 14. In particular, load bearing members 18 transfer the load downwards onto axle 14 via existing conventional bearings within bearing housings 22 mounted on the ends 14a of axles 14.

As described above, when substantial loads are applied downwardly to the laterally outermost ends 14a of axles 14, the result is a bending moment urging axles 14 to bow upwardly in direction A. Where, to applicant's knowledge, loads in the order of 60,000 lbs per axle are applied downwardly on ends 14a, the resulting bending moments, even though the moment arm between ends 14a and the fulcrum created where wheels 12 contact rail 16 is relatively short, can still result in significant torque about an axis parallel to rails 16. This results in an upward force tending to bow axles 14 upwardly in direction A as the bending resistance of axles 14, in combination with the bending arm distributed along the axles, resists the bending moment applied to the axles by the downward load onto ends 14a. It is understood however that it is merely applicant's understanding that these may be typical loads experienced by truck 10 and, as would be known to one skilled in the art, may vary significantly.

Consequently, due to the possible high loading and high bending moments to be resisted by axles 14, in order to achieve the advantages of decreased wear etc. that result from the use of a segmented axle, it should not be at the expense of the stiffness of the axle that resists the bending moment applied to it or results significantly in increased maintenance due to increased wear and tear of a segmented axle due to the combination of loads applied to it.

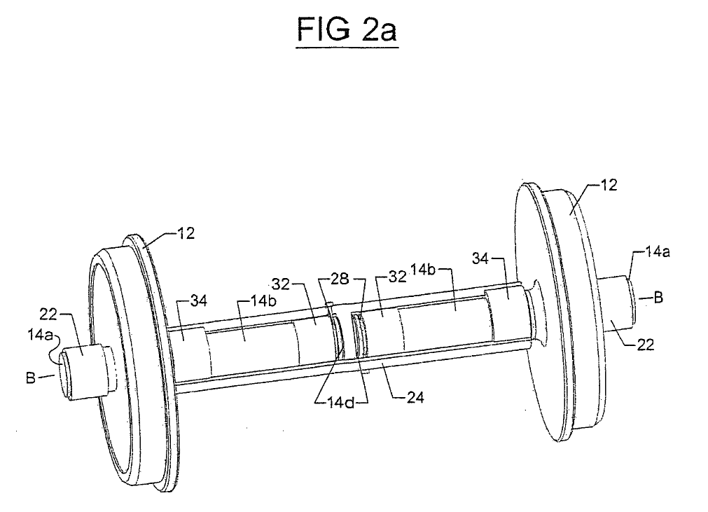

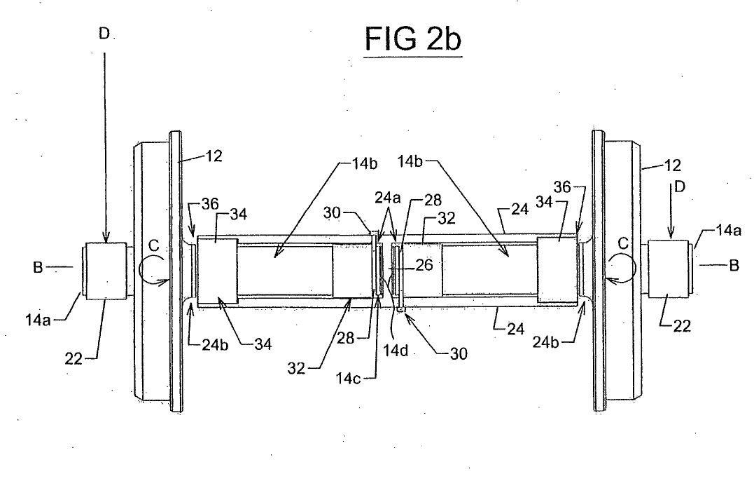

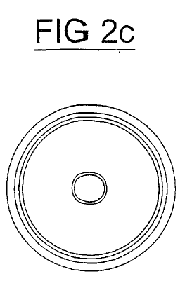

Thus in the present invention, in one preferred embodiment as seen in FIG. 2a, a conventional axle 14 may be cut in two, for example cut in half, to make two identical stub axles 14b each having opposed facing truncated or planar ends 14c.

In one embodiment, stub axles 14b are journalled in corresponding cavities or bores in tubular outer sleeve such as axle housing 24. The axle housing is a solid pipe that is cored out to allow the axle to be inserted. It is not a prefabricated pipe that us used, as there is a solid thickness of material left in the cored out section to which the thrust washer abuts in each of the 3 versions of the axle described herein. As see in FIG. 2b, opposed facing planar ends 14c seat using thrust washers 14d into corresponding pockets 24a formed on opposite sides of common wall 26. Reference to washers is intended to collectively include washers or bearings herein. Wall 26 separates ends 14c from each other by a spacing equal to the thickness of the wall 26 along centroidal axis of symmetry B. Nylon may be inserted or injected to provide low friction surfaces in place of bearings or bushings.

Annular grooves 28 are formed around the opposed facing ends of stub axles 14b behind planar ends 14c. A bolt 30 may be mounted through a corresponding bolt hole in axle housing 24 that corresponds in position to the location of annular grooves 28 so that bolt 30 may be mounted through the bolt hole and across a tangent to annular groove 28 to thereby releasably secure the stub axles 14b within axle housing 24 with ends 14c snugged against thrust washers in corresponding pockets 24a.

A pair of inner axle bushings 32 are mounted behind annular grooves 28 on their corresponding stub axles 14b so as to be tight to the inner ends of stub axles 14b or to housing 24.

Axle housing 24 extends substantially the entire length of the combined stub axles between wheels 12, that is, extends substantially the entire width between wheels 12 which is substantially equal to the width between rails 16. A second pair of bushings 34 are mounted between axle housing 24 and stub shafts 24b at substantially the laterally outermost ends of axle housing 24. Thus as may be seen, the lateral spacing between inner axle bushings 32 and outer axle bushings 34 is maintained substantially at a maximum width apart in order to minimize the load carried by those bearings in resisting bending moments C acting on stub axles 14b and axle housing 24 so as to bow axle housing 24 upwardly in direction A as a result of downward loads applied to ends 14a in direction D by the downward loading of load bearing members 18 acting on bearings 22.

Bushings 32 and 34 may be conventional bushings such as manufactured and sold by The Timken Company of Canton, Ohio or other brass, or nylon bearings as would be known to one skilled in the art.

In one embodiment where existing axles 14 are cut in two to make two substantially identical stub axles 14b, these axle stubs may be machined approximately one or two inches shorter in length than the cut length to accommodate a one or two inch space between their ends. The stub axles are machined to seat a six inch bushing or bearing 32. The recess corresponding to annular groove 28 may be set back approximately three-quarters of an inch, that is, three-quarters of an inch between the end of bushing 32 and the planar end 14c, thereby leaving enough room for the slots in the axle or grooves.

Axle housing 24 may be approximately four feet in length and approximately for example four inches larger in diameter than the diameter of stub axles 14b. The bores formed within axle housing 24, within which to house stub axles 14b, are machined from each of the opposite ends of axle housing 24 so as to leave a wall thickness of approximately one inch for wall 26, and have a diameter approximately one-quarter inch larger than the diameter of stub axles 14b. Thus the machined bores will have a bore diameter of approximately six to seven inches and, as stated above, will have planar end pockets.

The laterally outermost ends 24b of the bores will be machined to a larger inside diameter, for example so as to have an inside diameter approximately one inch larger than the diameter of stub axles 14b and about six inches in length so as to hold outer axle bushing 34 tight to axle housing 24 and so as to provide for mounting a dust seal 36 between the laterally outermost ends of axle housing 24 and wheels 12. Advantageously, the axle housing 24, once it has been machined to create the bores as described above, will retain a sufficient wall thickness so as to remain as stiff, that is, resistant to bending as would be the original solid axle 24 prior to being cut in two. In this preferred embodiment then any additional stiffness contributed by the mounting as described above of stub axles 14b into the bores within axle housing 24 only lend to improve the stiffness resistance to bending moment C. The fact that the diameter of axle housing 24 is greater than the diameter of the original axle 14, assists in attaining the sufficient at least equivalent stiffness with a reasonable wall thickness to axle housing 24. Although in a preferred embodiment axle housing 24 exhibits equivalent stiffness to the original uncut axle 14, in one embodiment, the equivalent stiffness is attained in combination with the bored out axle housing 24 being snugly fitted with stub axles 14b, that is snugly mounted at their ends, between wheels 12 in bushings 32 and 34.

The difference in rotational velocity of each of wheels 12 on opposite ends of axle housing 24 is of relatively small magnitude given the curvature encountered in typical curves found in rails 16. Thus, the differential rotation between the independent axle sections in the present invention, in this embodiment between the opposed facing stub axles 14b, within axle housing 24 is relatively small, allowing then for relatively tight packing or at least lending to increased support by stub axles 14b contributing to the improved bending stiffness of axle housing 24.

Although not illustrated, it would be understood to one skilled in the art that grease or other lubricant fittings would be provided for lubricating the slip joints for example in pockets 24a and bushings 32 and 34, and bearings 22. Stub axles 14b may have opposed facing planar surfaces to accommodate the fitting of thrust bearings or washers and, for example, shims in order to maintain the desired wheel width.

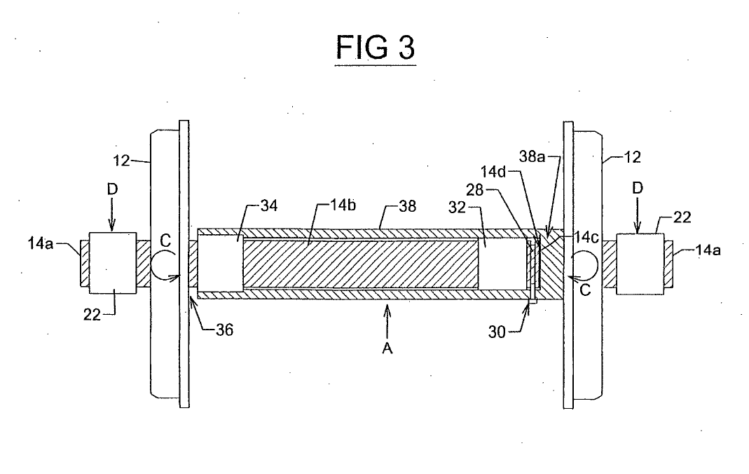

In the alternative embodiment of FIG. 3, instead of shaft 14 being severed into two substantially identical half lengths, shaft 14 has one end 14d severed laterally inwardly and adjacent wheel 12′. Again, as in the embodiment of FIG. 2, the severed end of the stub shaft 14b may be a planar end 14c as illustrated to accommodate thrust bearings, washers, shims etc. Whatever the shape of end 14c, a correspondingly shaped pocket 38a is formed in axle housing 38 to seat end 14c. As before, an annular groove 28 is formed behind end 14c so that stub shaft 14b may be releasably secured snugly within a corresponding bore in axle housing 38 by the use of a bolt 30 mounted through a hole (not shown) in axle housing 38 so as engage within annular groove 28. Again, a bushing 32 is mounted behind annular groove 28 tight onto stub axle 14b or housing 38. At the opposite end of stub shaft 14b, laterally to the inside and adjacent wheel 12, bushing 34 is mounted within an increased diameter bore so as to be tight to the axle housing 38. Again, a dust seal 36 is mounted between bushing 34 and wheel 12.

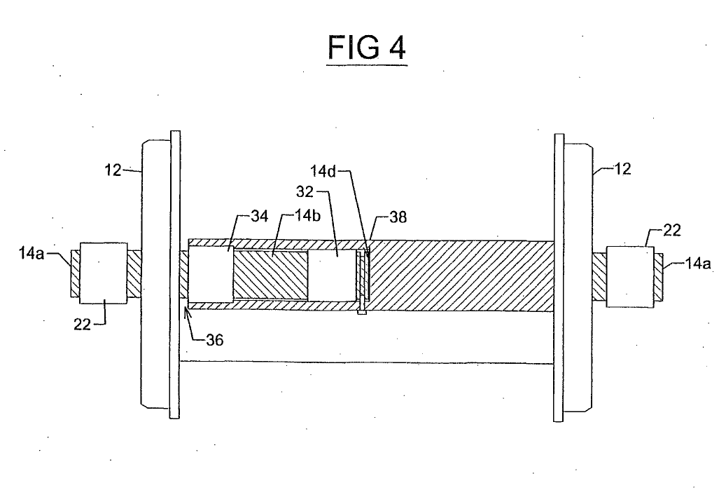

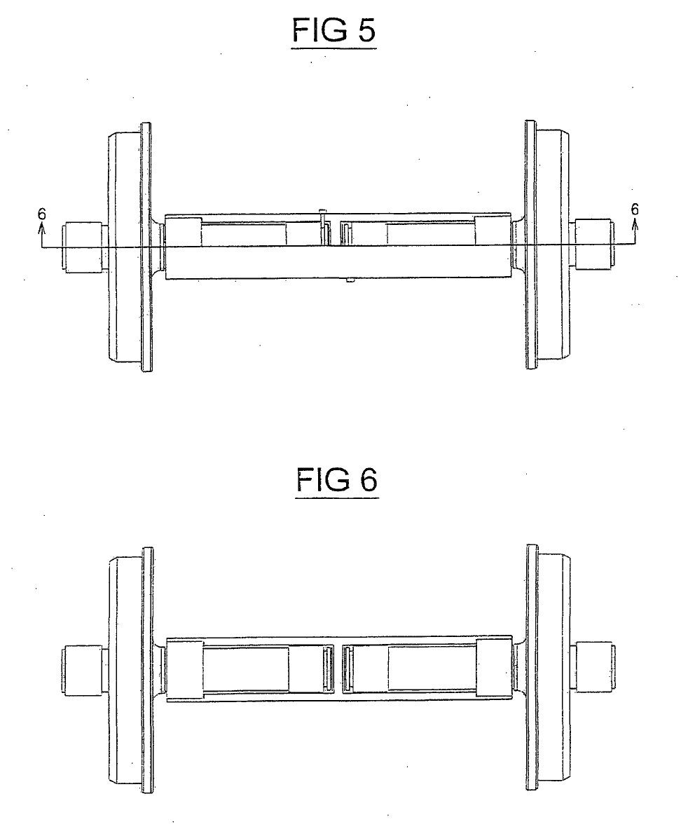

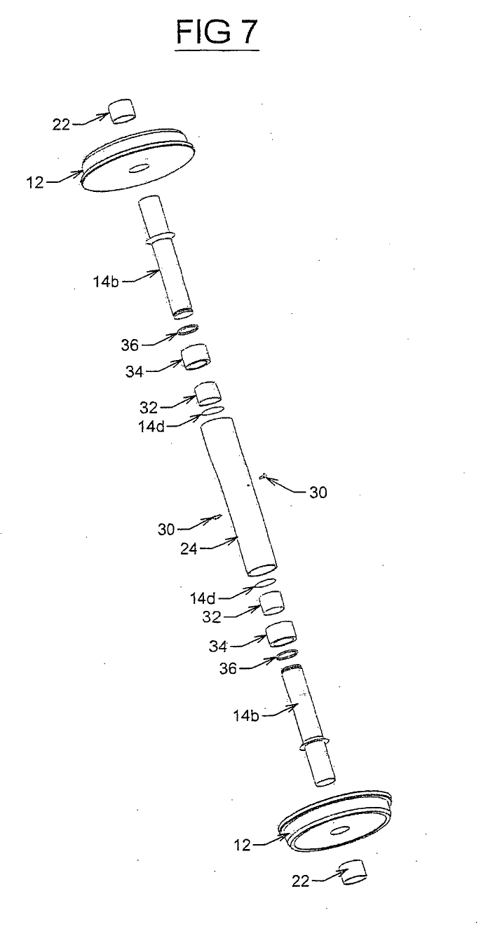

As seen in FIG. 4, stub shaft 14b may be of a shorter length than in the embodiment of FIG. 3. Thus stub shaft 14b may for example be approximately one half or more of the length of the housing 38, and is approximately one-half the length in the embodiment of FIG. 4. As described above, the planar end 14c may be a flat end in order to provide for seating of a thrust bearing or washers, and shims as necessary to maintain spacing between the wheels.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A railway car axle comprising:
a first stub axle having opposite inner and outer ends,
a rigid hollow sleeve having a first open end and an oppositely disposed first terminal end, and a first bore defined by a cylindrical wall extending from said first open end to said first terminal end, and wherein said first stub axle is journalled in said first bore so as to position said inner end of said first stub axle adjacent said first terminal end and so that said outer end of said first stub axle extends from said first open end,
separate first inner and first outer bearing housing, and corresponding first bearings, mounted so as to allow rotation of said first stub axle relative to said sleeve,
means for retaining said first stub axle in said first bore,
wherein said outer end of said first stub axle is adapted for mounting of a railway car wheel thereon and is further adapted for bearing a downward load associated with the railway car on load bearings mounted on an outermost end of said outer end of said first stub axle so as to be displaced laterally outwardly of the railway car wheel when mounted on said outer end of said first stub axle,
and wherein said cylindrical wall of said sleeve has a wall thickness, and wherein said wall thickness is sufficient to provide stiffness substantially equivalent to a stiffness afforded by a solid shaft of a length substantially equivalent to a corresponding length of said sleeve and wherein said solid shaft has a diameter substantially equivalent to a diameter of said first stub axle.

2. The axle of claim 1 wherein said first stub axle has a first length, and wherein said first length is at least substantially one-half of said length of said sleeve.

3. The axle of claim 1 wherein said first length is substantially equivalent to said length of said sleeve.

4. The axle of claim 2 further comprising:
a second bore formed in said sleeve oppositely disposed to and co-linearly with said first bore on opposite sides of a common terminal end wall disposed therebetween, wherein said second bore extends from a second open end to a second terminal end, and wherein said first and second terminal ends are oppositely disposed faces on said opposite sides of said common terminal end wall,
a second stub axle having opposite inner and outer ends and mounted in said second bore so as to position said inner end of said second stub axle adjacent said second terminal end and so that outer end of said second stub axle extends from said second open end,
separate second inner and second outer bearing housings, and corresponding second bearings, mounted so as to allow rotation of said second stub axle relative to said sleeve,
means for retaining said second stub axle in said second bore,
wherein said outer end of said second stub axle is adapted for mounting of a railway car wheel thereon and is further adapted for bearing a downward load associated with the railway car on load bearings mounted on an outermost end of said outer end of said second stub axle so as to be displaced laterally outwardly of the railway car wheel when mounted on said outer end of said second stub axle.

5. The axle of claim 4 wherein said diameter of said first stub axle is substantially equal to a diameter of said second stub axle.

6. The axle of claim 1 wherein said first terminal end is shaped so as to conform to said inner end of said first stub axle.

7. The axle of claim 6 wherein said inner end of said first stub axle is a truncated planar face.

8. The axle of claim 6 wherein said inner end of said first stub axle is truncated by a substantially planar face which is orthogonal to said bore.

9. The axle of claim 8 further comprising a thrust bearing mounted in said first terminal end adjacent said planar face.

10. The axle of claim 9 further comprising at least one shim mounted adjacent said thrust bearing.

11. The axle of claim 4 wherein said first and second terminal ends are shaped so as to conform to said inner ends of said first and second stub axles respectively.

12. The axle of claim 11 wherein said inner ends of said first and second stub axles are planar.

13. The axle of claim 11 wherein said inner ends of said first and second stub axles are truncated by a corresponding substantially planar faces orthogonal to said bore.

14. The axle of claim 13 further comprising thrust washers mounted in said first and second terminal ends adjacent said corresponding substantially planar faces.

15. The axle of claim 14 further comprising at least one shim mounted adjacent said thrust bearings.

16. The axle of claim 1 wherein said means for retaining said first stub axle in said first bore includes an annular groove in said first stub axle and a correspondingly positioned aperture in said sleeve for receiving therethrough a rigid elongate member into registry with said groove when said first stub axle is mounted in said first bore.

17. The axle of claim 16 wherein said aperture is a bolt hole and said member is a bolt.

18. The axle of claim 4 wherein said means for retaining said first stub axle in said first bore and said means for retaining said second stub axle in said second bore include annular grooves in said first and second stub axles and correspondingly positioned apertures in said sleeve for receiving therethrough rigid elongate members into registry with said grooves when said first and second stub axles are mounted in said first and second bores respectively.

19. The axle of claim 18 wherein said apertures are bolt holes and said members are bolts.
